(19) United States
(12) Patent Application Publication
(10) Pub. No.: US 2020/0320012 A1
(43) Pub. Date: Oct. 8, 2020

(54) MEMORY SYSTEM AND METHOD FOR OPERATING THE SAME

(71) Applicant: SK hynix Inc., Gyeonggi-do (KR)

(72) Inventor: Eu-Joon BYUN, Gyeonggi-do (KR)

(21) Appl. No.: 16/599,870

(22) Filed: Oct. 11, 2019

(30) Foreign Application Priority Data
Apr. 2, 2019 (KR) 10-2019-0038414

(51) Int. Cl. G06F 12/10

(52) U.S. Cl. CPC G06F 12/10; G06F 2212/657

(57) ABSTRACT

A data processing system includes a host; and a memory system suitable for outputting map information to the host; wherein the host is suitable for performing a mapping operation based on the map information and outputting, to the memory system, a physical address corresponding to the mapping operation, and wherein the memory system generates a response signal in response to a command, the response signal including changed map information which is changed after the map information is outputted and outputs the response signal to the host.

### CROSS-REFERENCE TO RELATED APPLICATIONS

The present application claims priority of Korean Patent Application No. 10-2019-0038414, filed on Apr. 2, 2019, which is incorporated herein by reference in its entirety.

### BACKGROUND

### 1. Field

Various embodiments of the present invention relate to a data processing system, and more particularly, to a memory system for efficiently performing a mapping operation, and a method for operating the data processing system.

### 2. Description of the Related Art

Recently, the paradigm for a computer environment is shifting into ubiquitous computing, which allows users to access computer systems anywhere and at anytime. The paradigm shift rapidly increases the use of portable electronic devices, such as mobile phones, digital cameras, and laptop computers. Such portable electronic devices may use a memory system which generally uses a memory device, in other words, a data storage device. The data storage device may be used as a main memory device or an auxiliary memory device of a portable electronic device.

The data storage device using a memory device is advantageous in that it has excellent stability and durability with quick data access rate and low power consumption because there is no mechanical driving part. As an example of the memory system having such advantages, the data storage device may include a universal serial bus (USB) memory device, a memory card having diverse interfaces, a solid state drive (SSD), and the like.

### SUMMARY

Embodiments of the present invention are directed to a memory system capable of generating a response signal including map information which is modified by a background operation and outputting the response signal.

In accordance with an embodiment of the present invention, a data processing system includes: a host; and a memory system suitable for outputting map information to the host, wherein the host is suitable for performing a mapping operation based on the map information and outputting, to the memory system, a physical address corresponding to the mapping operation, and wherein the memory system generates a response signal including changed map information which is changed after the map information is outputted and outputs the response signal to the host.

In accordance with another embodiment of the present invention, a memory system includes: a memory device; a host interface suitable for outputting map information; a program manager suitable for controlling the memory device to perform a program operation; a map manager unit suitable for updating the map information to generate updated map information; and a read manager suitable for controlling the memory device to perform a read operation based on an externally provided physical address, wherein the host interface generates a response signal in response to a command, the response signal including the updated map information after the map information is outputted, and outputs the response signal.

In accordance with yet another embodiment of the present invention, a method for operating a memory system includes: outputting map information; performing a program operation; updating the map information to generate updated map information; and performing a read operation based on an externally provided physical address, wherein the outputting of the map information includes, after the map information is outputted, generating and outputting a response signal in response to a command, the response signal including the updated map information after the map information is outputted.

In accordance with yet another embodiment of the present invention, a data processing system, includes: a host; and a memory system including a memory device, suitable for: transmitting map information to the host; performing a background operation on the memory device; updating the map information based on the background operation; generating a response signal in response to a command from the host, the response signal including updated map information; and transmitting the response signal to the host.

### BRIEF DESCRIPTION OF THE DRAWINGS

FIG. 1 is a block diagram illustrating a data processing system including a memory system in accordance with an embodiment of the present invention.

FIG. 2 is a flowchart illustrating a method of sharing map information in accordance with an embodiment of the present invention.

FIG. 3 illustrates a read operation between a host and a memory system in a data processing system in accordance with an embodiment of the present invention.

FIG. 4 is a diagram illustrating a transaction between a host and a memory system in a data processing system in accordance with an embodiment of the present invention.

FIGS. 5A and 5B are flowcharts illustrating operations of a host and a memory system in accordance with an embodiment of the present invention.

FIG. 6 is a flowchart illustrating an operation of a memory system in accordance with an embodiment of the present invention.

FIGS. 7A to 7D illustrate a map update operation in accordance with an embodiment of the present invention.

FIGS. 8A and 8B illustrate a method of performing a map update operation in accordance with an embodiment of the present invention.

FIG. 9 is a flowchart illustrating an operation of a memory system in accordance with an embodiment of the present invention.

FIG. 10 is a block diagram illustrating a memory system in accordance with an embodiment of the present invention.

FIG. 11 is a block diagram illustrating a memory system in accordance with an embodiment of the present invention.

### DETAILED DESCRIPTION

Various embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

It is noted that reference to “an embodiment,” “another embodiment” or the like does not necessarily mean only one embodiment, and different references to any such phrase are not necessarily to the same embodiment(s).

As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

Communication between two elements, whether directly or indirectly connected/coupled, may be wired or wireless, unless stated or the context indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Hereinafter, embodiments of the present invention will be described in detail with reference to the accompanying drawings.

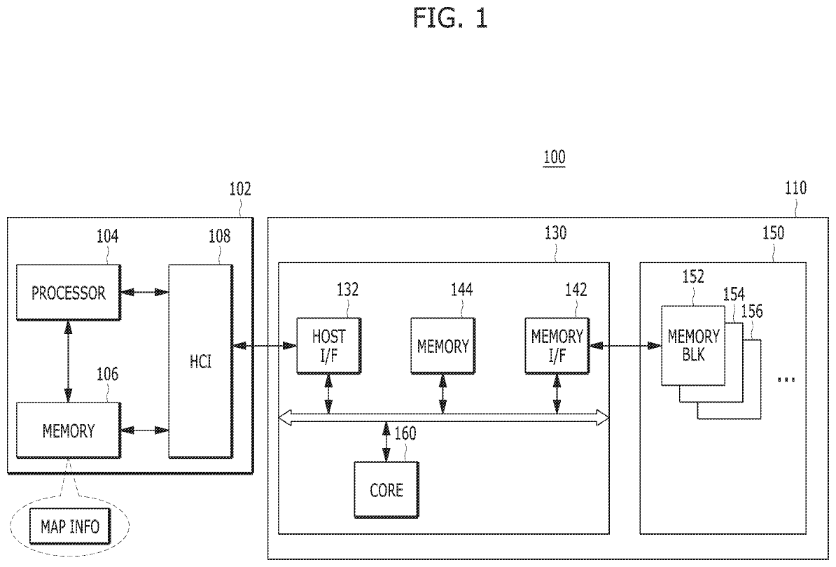

FIG. 1 is a block diagram illustrating a data processing system 100 including a memory system in accordance with an embodiment of the present invention.

Referring to FIG. 1, the data processing system 100 may include a host 102 and a memory system 110.

The host 102 may include a processor 104, a memory 106, and a host controller interface (HCI) 108.

The host 102 may include wired and wireless electronic devices, such as portable electronic devices (e.g., mobile phones, MP3 players, and laptop computers) and electronic devices (e.g., desktop computers, game players, televisions (TVs), and projectors).

The processor 104 may include at least one operating system (OS) and may execute the operating systems to perform an operation with the memory system 110 according to a user request. The processor 104 may generate a plurality of commands corresponding to the user request. The memory system 110 may perform operations corresponding to the commands, i.e., operations corresponding to the user request. The operating system may generally manage and control the function and operation of the host 102 and provide operations between the host 102 and a user using the data processing system 100 or the memory system 110.

The host memory 106 may store data for driving the host 102 and the memory system 110. Unlike a memory 144 in the memory system 110, using the host's memory 106 is advantageous in that there is less space constraints, and the hardware may be upgraded as needed. Accordingly, the memory system 110 may utilize the resources of the host 102 to increase the operation efficiency. In particular, the memory system 110 may store map information MAP INFO, which is information on a physical address corresponding to a logical address, in the memory 106. As will be described later, the processor 104 may provide the memory system 110 with not only a read command and a logical address but also the physical address by performing a mapping operation based on the map information MAP INFO stored in the memory 106. The mapping operation may be an operation of translating a logical address used in the host 102 into a physical address used in the memory system 110. The memory system 110 may not perform a mapping operation in response to the read command but perform a read operation quickly by reading the data stored in the physical address.

The host controller interface 108 may transfer a plurality of commands corresponding to the user request to the memory system 110 to control the memory system 110 to perform operations corresponding to the user request.

The memory system 110 may operate in response to a request from the host 102 and, in particular, may store data accessed by the host 102. The memory system 110 may be used as a main memory or an auxiliary memory of the host 102. The memory system 110 may be realized as any one among diverse types of storage devices, e.g., solid state drive (SSD), MMC, embedded MMC (eMMC) and the like, according to a host interface protocol for connection with the host 102.

Storage devices realizing the memory system 110 may be realized as a volatile memory device such as a dynamic random access memory (DRAM), static random access memory (SRAM) and the like, and a non-volatile memory device such as a read only memory (ROM), a mask ROM (MROM), a programmable ROM (PROM), an erasable ROM EPROM), an electrically erasable ROM (EEPROM), a ferromagnetic ROM (FRAM), a phase Change RAM (PRAM), a magnetic RAM (MRAM), a resistive RAM (RRAM), a flash memory and the like.

The memory system 110 may include a controller 130 and a memory device 150.

The controller 130 and the memory device 150 may be integrated into one semiconductor device. For example, the controller 130 and the memory device 150 may be integrated into one semiconductor device and may form an SSD, a personal computer memory card international association (PCMCIA: PC card), a secure digital (SD) card (e.g., SD, miniSD, microSD, SDHC) a universal flash storage device (UFS) or the like. Also, as another example, the memory system 110 may be integrated into one element among the diverse constituent elements, such as, a computer, a smart phone, a portable game player, that form a computing system and the like.

The memory device 150 may retain the stored data even when power is not supplied. In particular, the memory device 150 may store the data provided from the host 102 through a program operation, and provide the host 102 with the data stored through a read operation. The memory device 150 may include a plurality of memory blocks 152, 154 and 156. Each of the memory blocks 152, 154 and 156 may include a plurality of pages. Each of the pages may include a plurality of memory cells that are coupled to a plurality of word lines WL. The memory device 150 may also include a plurality of memory dies. Each of the memory dies may include a plurality of planes. Each of the planes may include a plurality of memory blocks 152, 154 and 156. The memory device 150 may be a non-volatile memory device, e.g., a flash memory, having a three-dimensional stereoscopic stack structure.

The controller 130 may control the memory device 150 in response to a request from the host 102. For example, the controller 130 may provide the host 102 with the data that are read from the memory device 150, store the data provided from the host 102 in the memory device 150, and control the memory device 150 to perform a program operation and an erase operation.

The controller 130 may include a host interface (I/F) 132, a core 160, a memory interface (I/F) 142, and a memory 144.

The host interface 132 may process commands and data of the host 102. The host interface 132 may be formed to communicate with the host 102 based on at least one protocol among diverse interface protocols, such as universal serial bus (USB), serial advanced technology attachment (SATA), small computer system interface (SCSI), and enhanced small disk interface (ESDI). The host interface 132 may be an area for exchanging data with the host 102. The host interface 132 may be driven based on firmware which is called a host interface layer (HIL).

The memory interface 142 may be a memory or storage interface that performs interfacing between the controller 130 and the memory device 150 for the controller 130 to control the memory device 150 in response to a request from the host 102.

The memory 144 may be an operation memory of the memory system 110. The controller 130 and the memory 144 may store data for driving the memory system 110 and the controller 130.

The memory 144 may be realized as a volatile memory, for example, a static random access memory (SRAM) or a dynamic random access memory (DRAM). The memory 144 may be in the inside of the controller 130 or in the outside of the controller 130. The memory 144 may be realized as an external volatile memory which exchanges data with the controller 130 through a memory interface.

The memory 144 may store the data needed for performing operations such as a program operation and a read operation between the host 102 and the memory device 150, and the data produced while an operation, such as a program operation and a read operation, is performed. The memory 144 may include a program memory, a data memory, a write buffer/cache, a read buffer/cache, a data buffer/cache, a map buffer/cache, and so forth.

The core 160 may control the overall operation of the memory system 110. In particular, the core 160 may control a program operation or a read operation that is performed on the memory system 110 in response to a program request or a read request applied from the host 102. The core 160 may be able to drive firmware called a flash translation layer (FTL) in order to control the general operations of the memory system 110. The core 160 may be realized as a microprocessor or a central processing unit (CPU).

The controller 130 may be able to perform an operation is requested by the host 102 in the memory device 150 through the core 160. The controller 130 may also be able to perform a background operation for the memory device 150 through the core 160. The background operation for the memory device 150 may include, for example, a garbage collection (GC) operation, a wear leveling (WL) operation, a map flush operation, and a bad block management operation.

The core 160 may perform a mapping operation for coupling a file system used by the host 102 to a storage space of the memory device 150. An address of data according to the file system used by the host 102 may be referred to as a logical address or a logical block address. An address of data in the storage space including a non-volatile memory cell may be referred to as a physical address or a physical block address. When the host 102 provides the memory system 110 with a logical address together with a read command, the core 160 may control the memory device 150 to load the map information MAP INFO stored in the memory device 150 into the memory 144, perform a mapping operation, and read the data stored in a physical address corresponding to the logical address.

As the amount of data that may be stored in the memory device 150 increases, the amount of map information MAP INFO for the data stored in the memory device 150 may increase as well. Since the space of the memory 144 is limited, the size of the map information MAP INFO by which the core 160 can load the map is information MAP INFO stored in the memory device 150, may have a limitation. Therefore, the core 160 may be able to load only the map information MAP INFO for some data into the memory 144, instead of loading the map information MAP INFO for all the data stored in the memory device 150.

As the amount of map information MAP INFO increases, the core 160 may frequently load the map information MAP INFO in order to perform a mapping operation. When the map information MAP INFO for the logical address to be accessed by the host 102 is not loaded into the memory 144, the core 160 may control the memory device 150 to read the map information MAP INFO from memory blocks and load the map information MAP INFO into the memory 144. When a part of the map information MAP INFO loaded in the memory 144 is updated, the core 160 may control the memory device 150 to program the map information MAP INFO into memory blocks and update the map information MAP INFO of the memory device 150. The loading and updating the map information MAP INFO by the core 160 may be performed in order to perform a read operation or a program operation which is requested by the host 102. As the read or program operation is repeatedly performed, the performance of the memory system 110 may be degraded.

When the host 102 is capable of performing a mapping operation performed by the core 160, the core 160 may omit the mapping operation and control the memory device 150 to access a is physical address provided from the host 102. Therefore, the operation load caused when the core 160 uses the memory 144 may be alleviated so that the operation efficiency of the memory system 110 may be increased, and the time required for the memory system 110 to output the data corresponding to a read command provided by the host 102 may be decreased.

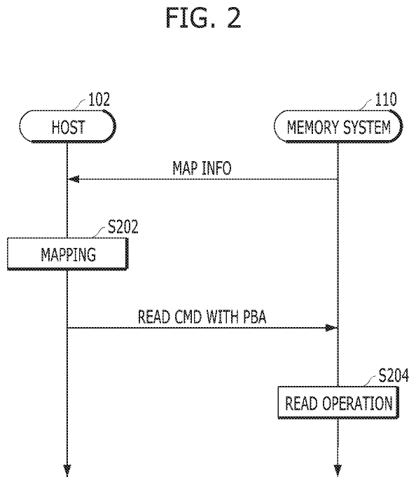

FIG. 2 is a flowchart illustrating a method of sharing map information in accordance with an embodiment of the present invention.

Referring to FIG. 2, the host 02 may store map information MAP INFO for performing a mapping operation in the memory 106. The memory system 110 may provide the host 102 with map information MAP INFO. It may be difficult for the host 102 to allocate storage space in the memory 106 to store the whole map information MAP INFO stored in the memory system 110. Thus, the memory system 110 may selectively provide the host 102 with the map information MAP INFO for data or logical addresses that are frequently used by the host 102.

The host 102 may store the map information MAP INFO in the memory 106. In an embodiment, the host 102 may delete old map information MAP INFO out of the memory 106 according to the time order that the map information MAP is provided from the memory system 110. The provided map information MAP INFO may include update information. Since the memory 106 is formed of a volatile memory cell, the host 102 may update the map information MAP INFO which corresponds to the update information and store the updated map information MAP INFO in the memory 106 without deleting other map information MAP INFO.

In step S202, the host 102 may perform a mapping operation based on the map information MAP INFO stored in the memory 106. The host 102 may search for a physical address corresponding to a logical address for a read command that is provided to the memory system 110 based on the map information MAP INFO. When the map information MAP INFO includes the physical address corresponding to the logical address for the read command, the host 102 may provide the memory system 110 with a read command including the physical address “READ CMD WITH PBA”.

In step S204, the memory system 110 may perform a read operation in response to the read command. The memory system 110 may read the data stored in the physical address without performing a separate mapping operation based on the physical address in the read command. When the host 102 performs a direct mapping operation and provides a read command, a logical address, and a physical address to the memory system 110, the memory system 110 may access the data based on the physical address and output the data, decreasing the time required for the read operation.

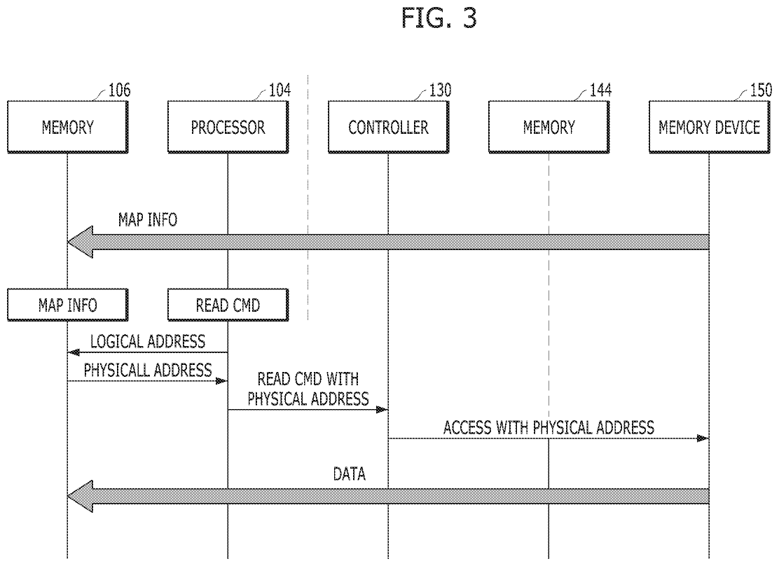

FIG. 3 illustrates a read operation between the host 102 and the memory system 110 in the data processing system 100 in accordance with an embodiment of the present invention.

When power is supplied to the host 102 and the memory system 110, the host 102 and the memory system 110 may interlock with each other, and the memory system 110 may provide the memory 106 of the host 102 (hereinafter, referred to as host memory 106) with the map information MAP INFO stored in the memory device 150.

The processor 104 of the host 102 may generate a read command READ CMD and perform a mapping operation of searching for the physical address corresponding to the logical address for the read command READ CMD based on the map information MAP INFO stored in the host memory 106. The processor 104 may provide the controller 130 with the physical address which is searched according to the mapping operation, together with the read command READ CMD. The controller 130 may access the memory device 150 based on the physical address and the read command READ CMD. The memory device 150 may read the data DATA stored in the physical address and provide the host memory 106 with the data.

The operation of reading the data in the memory device 150 including a non-volatile memory device may consume more time than the operation of reading the data from a volatile memory, such as the host memory 106. In the case of the above-described read operation, a mapping operation performed by the controller 130 may be omitted. In particular, in order to search for the physical address corresponding to the logical address for a read command, the operation of accessing the memory device 150 and reading the map information MAP INFO by the controller 130 may be omitted. Thus, the operation of reading the data stored in the memory system 110 by the host 102 may be performed more quickly.

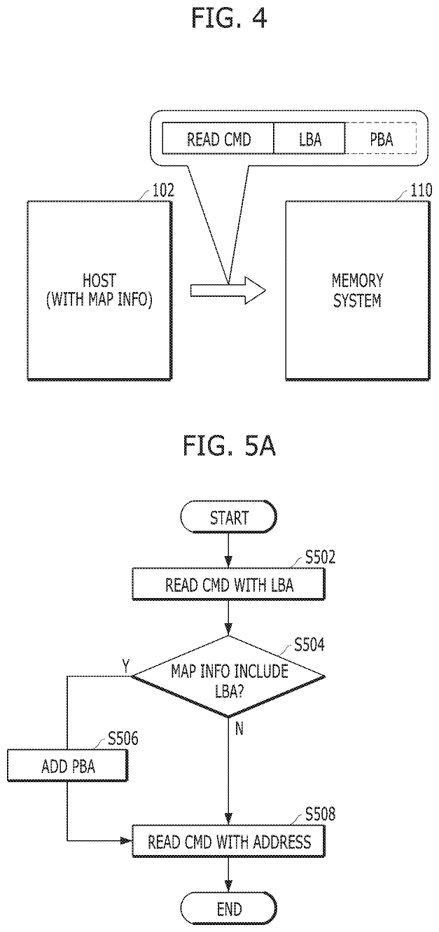

FIG. 4 is a diagram illustrating a transaction between the host and the memory system in the data processing system in accordance with the embodiment of the present invention.

Referring to FIG. 4, the host 102 storing the map information MAP INFO may provide the memory system 110 with a read command including a logical address LBA and a physical address PBA. When the map information MAP INFO stored in the host 102 includes the physical address PBA corresponding to the logical address LBA for the read command, the host 102 may provide the memory system 110 with the read command that includes the logical address LBA and the physical address PBA. When the map information MAP INFO stored in the host 102 does not include a physical address PBA corresponding to the logical address LBA for the read command, the host 102 may provide the memory system 110 with a read command which includes only the logical address LBA excluding the physical address. Although FIG. 4 illustrates a read command as an example, the present invention may be applied to a delete command which may be provided by the host 102 to the memory system 110 according to some embodiments of the present invention.

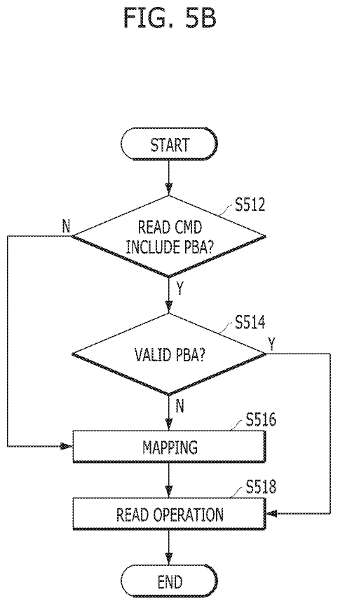

FIGS. 5A and 5B are flowcharts illustrating operations of the host and the memory system in accordance with the embodiment of the present invention.

FIG. 5A illustrates an operation of providing, by the host 102, the memory system 110 with a read command READ CMD that includes a logical address LBA and a physical address PBA.

Referring to FIG. 5A, in step S502, the host 102 may generate a read command READ CMD including a logical address LBA. As described earlier with reference to FIG. 1, the processor 104 may generate the read command for a logical address LBA.

In step S504, the host 102 may check whether or not map information for the logical address LBA exists in the host memory 106. As described above with reference to FIG. 3, the host memory 106 may store map information MAP INFO provided from the memory system 110. The processor 104 may be able to check whether or not the map information MAP INFO stored in the memory 106 includes the map information for the logical address LBA for the read command READ CMD. The map information MAP INFO may be logical to physical (L2P) information, which is information on a physical address corresponding to a logical address.

In step S506, when it is checked that the map information MAP INFO includes map information for the logical address LBA (“Y” in the step S504), the host 102 may perform a mapping operation to search for the physical address PBA corresponding to the logical address LBA. The host 102 may add the physical address PBA to the read command READ CMD including the logical address LBA which is generated in the step S502. When the map information MAP INFO stored in the host memory 106 includes map information for the logical address LBA for the read command READ CMD, the host 102 may perform a direct mapping operation to provide the memory system 110 with a physical address PBA. Therefore, the speed of a read operation of the memory system 110 may be improved.

In step S508, the host 102 may provide the memory system 110 with a read command including the address information “READ CMD WITH ADDRESS”. The address information may include a logical address LBA or a physical address PBA. Specifically, when the map information MAP INFO does not include the map information for the logical address LBA (“N” in the step S504), the host 102 may provide the memory system 110 with a read command including the logical address “READ CMD LBA”. When a physical address PBA is included in the read command including the logical address in the step S506, the host 102 may provide the memory system 110 with the read command including the logical address LBA and the physical address PBA.

FIG. 5B illustrates an operation, by the memory system 110, that has received the read command READ CMD including the logical address LBA and the physical address PBA.

Referring to FIG. 5B, in step S512, the memory system 110 may check whether or not the read command READ CMD received from the host 102 includes a physical address PBA. As described above with reference to FIG. 5A, when the host 102 performs a direct mapping operation, the read command READ CMD may include a physical address PBA.

In step S514, when the read command READ CMD includes a physical address PBA (“Y” in the step S512), the memory system 110 may check the validity of the physical address PBA. As described above, the memory system 110 may provide the host 102 with map information MAP INFO, and the host 102 may perform a mapping operation based on the map information MAP INFO. The host 102 may include the physical address PBA that is searched according to the mapping operation in the read command READ CMD and provide the memory device 110 with the read command READ CMD including the physical address PBA. After the memory system 110 provides the host 102 with the MAP information, the MAP information stored in the memory system 110 may be changed or updated to be changed into a dirty state. When the map information is in a dirty state, the physical address PBA may not be valid because the memory system 110 may not use the physical address PBA which is provided by the host 102.

In step S516, the memory system 110 may perform a mapping operation based on the logical address which is included in the received read command READ CMD. Specifically, when the received read command READ CMD does not include the physical address PBA (“N” in the step S512) or the physical address PBA included in the received read command is not valid (“N” in the step S514), the memory system 110 may perform a mapping operation to search for a physical address PBA corresponding to the logical address LBA in the received read command READ CMD.

In step S518, when the physical address PBA in the received read command READ CMD is valid (“Y” in the step S514) or a physical address PBA is searched according to the mapping operation performed by the memory system 110 in the step S516, the memory system 110 may read the data stored at the physical address PBA in response to the read command READ CMD. When the physical address PBA provided to the memory system 110 according to the mapping operation directly performed by the host 102 is valid, the memory system 110 may not perform a mapping operation separately but quickly performs a read operation by immediately reading the data stored in the physical address PBA in response to the read command READ CMD.

Since it is inherently impossible to overwrite a flash memory, the memory system 110 may invalidate the physical address where the old data for the logical address is stored in order to program the latest data for a particular logical address and update the map information MAP INFO with a new physical address corresponding to the logical address. As described above, the physical address PBA should be valid, in order for the memory system 110 to read the data stored at the physical address PBA provided from the host 102 without performing a mapping operation.

After the memory system 110 provides the host 102 with the map information MAP INFO, when a program command for the logical address in the map information MAP INFO is issued and the memory system 110 performs a program operation, the memory system 110 may update the map information MAP INFO with a new physical address for the logical address. Thereafter, when a read command for the logical address is issued, the host 102 may perform a mapping operation based on the map information MAP INFO that is not updated and provide the memory system 110 with a physical address PBA, and the physical address PBA may not be valid. Therefore, since the memory system 110 has to perform a mapping operation before performing a read operation in response to the read command, the physical address provided by the host 102 may not be used at all.

According to an embodiment, whenever the host 102 issues a program command PGM CMD for a particular logical address, the memory system 110 may perform a program operation and update the map information MAP INFO to include the map information MAP INFO into a response signal RESPONSE for the program command. The memory system 110 may provide the host 102 with the response signal RESPONSE including the map information MAP INFO. Therefore, the host 102 may update the map information MAP INFO stored in the memory 106 based on the updated map information MAP INFO. When the read command for the logical address is issued later, the host 102 may perform a mapping operation based on the updated map information MAP INFO. The host 102 may provide the memory system 110 with the latest physical information corresponding to the logical address. According to an embodiment of the present invention, since the validity of the physical address provided from the host 102 may be ensured, the memory system 110 may not perform a mapping operation separately, and quickly reads data from the physical address.

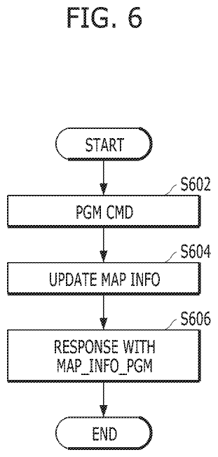

FIG. 6 is a flowchart illustrating an operation of the memory system 110 in accordance with an embodiment of the present invention.

Referring to FIG. 6, in step S602, the host 102 may provide the controller 130 with a program command PGM CMD, a logical address, and data. The controller 130 may control the memory device 150 to program the data in an open block in response to the program command PGM CMD. As described above, when the old data for the logical address is already programmed in a memory block, the controller 130 may not perform an overwrite operation of programming the latest data at the position where the old data is programmed due to the inherent characteristics of a flash memory. Therefore, the controller 130 may control the memory device 150 to invalidate the page including the old data so as to produce an empty page and program the latest data in the empty page.

In step S604, the controller 130 may update the changed map information MAP INFO according to the program operation performed in the step S602. The map information MAP INFO may be logical to physical (L2P) information on a physical address corresponding to a logical address. The controller 130 may update the map information MAP INFO with the latest physical address where the data on the program command PGM CMD is stored according to the program operation. For example, the controller 130 may update the map information MAP INFO by loading the map information MAP INFO for the logical address corresponding to the program command PGM CMD into the memory 144 and then control the memory device 150 to program the map information MAP INFO in a non-volatile memory.

In step S606, the controller 130 may provide the host 102 with a response signal RESPONSE to the program command. The response signal RESPONSE may include information indicating whether the program operation has succeeded or not. According to the first embodiment of the present invention, the controller 130 may include map information MAP_INFO_PGM which is changed according to the program operation into the response signal RESPONSE. The controller 130 may provide the host 102 with the response signal RESPONSE including the changed map information MAP_INFO_PGM. The host 102 may update the map information MAP INFO stored in the host memory 106 based on the provided map information MAP_INFO_PGM. When a read command is issued later for a logical address which is identical to the logical address corresponding to the program command PGM CMD, the host 102 may perform a mapping operation based on the updated map information MAP INFO.

According to the first embodiment of the present invention, the memory system 110 may provide the host 102 with the map information MAP_INFO_PGM which is changed according to the program operation performed in response to a program command PGM CMD. The host 102 may update the map information MAP INFO stored in the host memory 106 based on the map information MAP_INFO_PGM. However, the map information MAP INFO of the memory system 110 may be changed not only by a program operation performed in response to the program command PGM CMD but also by a background operation BOP, which is described with reference to FIG. 1.

According to the first embodiment of the present invention, since the memory system 110 does not provide the map information MAP INFO changed by the background operation BOP to the host 102, the host 102 may not update the map information MAP INFO stored in the memory 106 based on the map information MAP INFO.

Therefore, when the read command for the logical address corresponding to the map information MAP INFO changed by the background operation BOP is issued later, the host 102 may perform a mapping operation based on the map information MAP INFO before the update. Therefore, the host 102 may provide the memory system 110 with a physical address that is not valid, and the memory system 110 may not use the physical address, but may have to additionally perform a mapping operation.

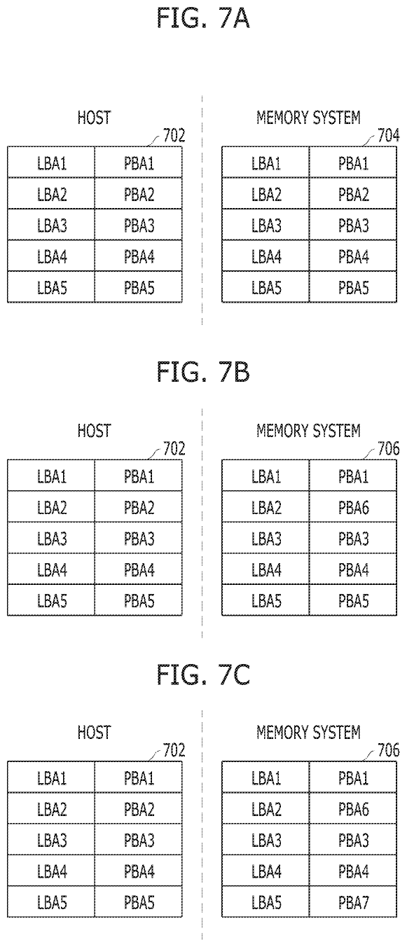

FIGS. 7A to 7D illustrate a map update operation in accordance with an embodiment of the present invention.

By way of example, map information on the physical addresses corresponding to five logical addresses will be described.

FIG. 7A illustrates an initial state of map information stored in the host 102 and the memory system 110.

As described above with reference to FIG. 2, the memory system 110 may selectively provide the host 102 with map information for logical addresses that the host 102 frequently uses. The first to fifth logical addresses LBA1 to LBA5 shown in FIG. 7A may be an example of a logical address selected by the memory system 110. The memory 144 may store map information 704 for the first to fifth logical addresses LBA1 to LBA5. The map information 704 may include logical to physical (L2P) information for the first to fifth logical addresses LBA1 to LBA5. Referring to FIG. 7A, the physical addresses for the first to fifth logical addresses LBA1 to LBA5 may be first to fifth physical addresses PBA1 to PBA5, respectively. The memory system 110 may provide the host 102 with the map information 704.

The host 102 may store the provided map information 704 in the host memory 106. Right after the memory system 110 provides the host 102 with the map information 704, that is, in the initial state, the map information 702 stored in the host memory 106 may be the same as the map information 704 stored in the memory 144. Referring to FIG. 7A, it may be seen that the physical addresses for the first to fifth logical addresses LBA1 to LBA5 of the map information 702 stored in the host memory 106 are respectively the first to fifth physical addresses PBA1 to PBA5, and thus the map information 702 stored in the host memory 106 may be the same as the map information 704 stored in the memory 144.

FIG. 7B illustrates map information stored in the host 1.02 and the memory system 110 after a background operation.

The memory system 110 may perform a background operation after providing the map information 704 to the host 102. Since the background operation may include a program operation, the map information stored in the memory 144 may be changed according to the background operation. For example, when a garbage collection operation is performed on a memory block for a second physical address PBA2 corresponding to a second logical address LBA2, the memory system 110 may read the data stored at the second physical address PBA2 and program the read data in a new physical address, e.g., a sixth physical address PBA6. The memory system 110 may generate updated map information 706 by changing the physical address corresponding to the second logical address LBA2 into the sixth physical address PBA6. The physical address corresponding to the second logical address LBA2 may be included in the initial map information 704 that is stored in the memory 144.

According to an embodiment, the host 102 may not update the map information 702 stored in the memory 106 into the changed map information 706 according to the background operation. Referring to FIG. 7B, it may be seen that the map information 702 stored in the memory 106 is the same as the map information 704 which is stored in the memory 144 in the initial state.

FIG. 7C illustrates map information stored in the host 102 and the memory system 110, before providing the host 102 with a response signal to the program command after the program operation is performed in response to the program command.

The host 102 may provide the memory system 110 with a program command, a logical address, and data. The memory system 110 may program the data in an open block in response to the program command and update map information for the logical address. For example, when the host 102 issues a program command for the fifth logical address LBA5, the memory system 110 may program the data for the program command into a seventh physical address PBA7, which is a new physical address. The memory system 110 may invalidate the fifth physical address PBA5 corresponding to the fifth logical address LBA5 based on the old map information 706. Further, the memory system 110 may generate updated map information 708 by changing the physical address for the fifth logical address LBA5 into the seventh physical address PBA7.

Referring to FIG. 7C, it may be seen that the physical address for the fifth logical address LBA5 is changed into the seventh physical address PBA7 in the map information 708 stored in the memory 144. Since FIG. 7C shows the map information 702 stored in the host memory 106 before providing the host 102 with a response to the program command after the program operation performed in response to the program command, it may be seen that the map information 702 is the same as the map information 704 stored in the memory 144 in the initial state.

FIG. 7D illustrates map information stored in the host 102 and the memory system 110 after the host 102 updates the map information MAP INFO.

The memory system 110 may provide the host 102 with map information MAP INFO PGM which is changed according to a program operation together with a response signal RESPONSE to a program command after performing the program operation in response to the program command. The host 102 may update the map information MAP INFO stored in the memory 106 based on the provided map information MAP INFO PGM. Referring to FIG. 7D, the memory system 110 may output the physical address information for the fifth logical address LBA5 changed according to the program operation performed in response to the program command together with a is response signal to the program command. The host 102 may generate updated map information 710 by updating the physical address for the fifth logical address LBA5 into the seventh physical address PBA7 based on the physical address information for the changed fifth logical address LBA5.

According to an embodiment, since the memory system 110 provides the host 102 with only the map information MAP INFO PGM which is changed according to the program operation performed in response to the program command, it may not provide the host 102 with the map information MAP INFO BOP which is changed according to a background operation. Therefore, the host 102 may be able to only update the map information stored in the memory 106 based on only the map information MAP INFO PGM which is changed according to the program operation performed in response to the program command. Further, the host 102 may not be able to update the map information for the map information MAP INFO BOP according to a background operation. Therefore, when a read command is issued for a logical address corresponding to the map information MAP INFO BOP which is changed according to the background operation later, the host 102 may fail to perform the mapping operation based on the latest physical address information. When the physical address provided together with the read command to the memory system 110 according to the mapping operation performed by the host 102 is not valid, it takes a long time to perform a read operation because the is memory system 110 needs to perform the mapping operation before performing a read operation.

Referring to FIG. 7D, since the memory system 110 may not provide the host 102 with the map information MAP INFO BOP for the second logical address LBA2 which is changed by the background operation, the host 102 may not update the map information 710 stored in the memory 106 into the changed physical address for the second logical address LBA2. When a read command for the second logical address LBA2 is issued later, the host 102 may perform a mapping operation based on the map information 710. Further, the host 102 may provide the memory system 110 with the second physical address PBA2 together with the read command and the second logical addresses LBA2. Since the second physical address PBA2 is not valid as a physical address for the second logical address LBA2, the memory system 110 may search the map information 708 stored in the memory 144 for the sixth physical address PBA6 as a valid physical address for the second logical address LBA2 by performing a mapping operation prior to performing a read operation. Due to the provided invalid physical address, the frequency of the memory system 110 performing a mapping operation itself increases and the time required for performing a read operation increases as well.

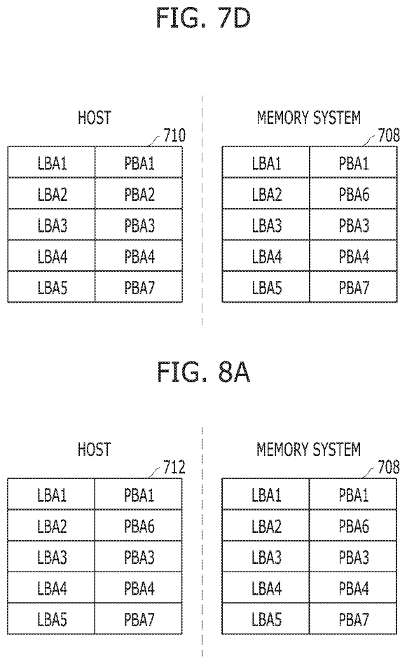

FIGS. 8A and 8B illustrate a method of performing a map update operation in accordance with an embodiment of the present invention.

According to another embodiment, whenever the memory system 110 outputs a response signal to a command provided from the host 102, the memory system 110 may output map information which is changed according to a background operation together with the response signal. The command may include diverse commands provided from the host 102, such as a read command, a program command, and an erase command. The host 102 may update the map information stored in the memory 106 based on the map information which is provided together with the response signal. When a read command is issued for a logical address corresponding to the map information which is changed according to a background operation later, the host 102 may perform a mapping operation based on the latest map information. The host 102 may provide the memory system 110 with the physical address by searching for a physical address corresponding to the logical address according to the mapping operation. Since the physical address is highly likely to be valid, the memory system 110 may perform a read operation from the physical address immediately without performing a separate mapping operation. In this way, the speed of the read operation may be improved.

Referring to FIG. 8A, when a command is provided from the host 102, the memory system 110 may output map information for the second logical address LBA2 which is changed by a background operation together with the response signal to the command. The host 102 may update the map information 712 stored in the memory 106 based on the provided map information. The host 102 may update the physical address for the second logical address LBA2 into the sixth physical address PBA6 in the map information 712. Therefore, when the read command for the second logical address LBA2 is issued later, the host 102 may perform a mapping operation based on the updated map information 712. Further, the host 102 may provide the memory system 110 with the sixth physical address PBA6, which is the latest physical address corresponding to the second logical address LBA2. Since the sixth physical address PBA6 is valid, the memory system 110 may read data stored in the sixth physical address PBA6 without performing a separate mapping operation. According to the second embodiment, the memory system 110 may secure the validity of the physical address which is outputted by the host 102 by providing the host 102 with the map information that is changed by a background operation. When the validity of the physical address is secured, the frequency of the memory system 110 performing a mapping operation may be lowered. As a result, the speed of a read operation may be improved.

FIG. 8B illustrates a data structure of a response signal to a command.

Referring to FIG. 8B, the response signal RESPONSE to the command may include a first region for storing information indicating the type of command CMD TYPE and a second region for storing information indicating whether an operation corresponding to the command is successful or not. Further, the response signal RESPONSE may include a reserve region. The reserve region may be a space reserved for the memory system 110 to include additional information in the response signal RESPONSE other than the information in the first region and the second region. The memory system 110 may include the map information which is changed by a background operation in the reserve region. The map information may include a logical address LBA and a physical address PBA corresponding to the logical address.

When a response signal RESPONSE to a read command is outputted, the memory system 110 may store an identifier and information indicating pass or failure for the read command in the first region and the second region of the response signal RESPONSE, respectively. The memory system 110 may store the map information MAP INFO BOP which is changed by a background operation in the reserve region of the response signal RESPONSE. Referring to FIGS. 7A to 7D, when the host 102 provides a read command after the background command is performed and the physical address corresponding to the second logical address LBA2 was changed into the sixth physical address PBA6, the memory system 110 may include information on the second logical address LBA2 and the sixth physical address PBA6 corresponding to the second logical address LBA2 in the reserve region of the response signal RESPONSE in response to the read command. Further, the memory system 110 may provide the host 102 with the response signal RESPONSE including the information on the second logical address LBA2 and the sixth physical address PBA6 corresponding to the second logical address LBA2.

When a response signal RESPONSE to a program command is outputted, the memory system 110 may store all of the map information MAP INFO PGM and the map information MAP INFO BOP in the reserve region of the response signal RESPONSE. The map information MAP INFO PGM may be changed according to a program operation performed in response to the program command PGM CMD. The map information MAP INFO BOP may be changed by a background operation. With reference to FIG. 7A to 7D, when a program command is received from the host 102 after the physical address corresponding to the second logical address LBA2 is changed into the sixth physical address PBA6 by a background operation, the physical address corresponding to the fifth logical address LBA5 may be changed into a seventh physical address LBA7 according to a program operation corresponding to the program command. The memory system 110 may generate the response signal RESPONSE including the reserve region and provide the host 102 with the response signal RESPONSE. The reserve region of the response signal RESPONSE may include information on the second logical address LBA2, the sixth physical address PBA6 corresponding to the second logical address, the fifth logical address LBA5 and the seventh physical address LBA7 corresponding to the fifth logical address.

The capacity of the reserve region may be limited, and the size of the map information changed according to a background operation may exceed the capacity of the reserve region. The memory system 110 may store the map information which is changed by a background operation in the form of a list. Whenever the response signal RESPONSE to a command is outputted, only the map information having as much as the capacity of the reserve region of the response signal RESPONSE among the map information in the list may be included in reserve region. The memory system 110 may delete the map information which is provided to the host 102 by being included in the reserve region of the response signal RESPONSE from the list.

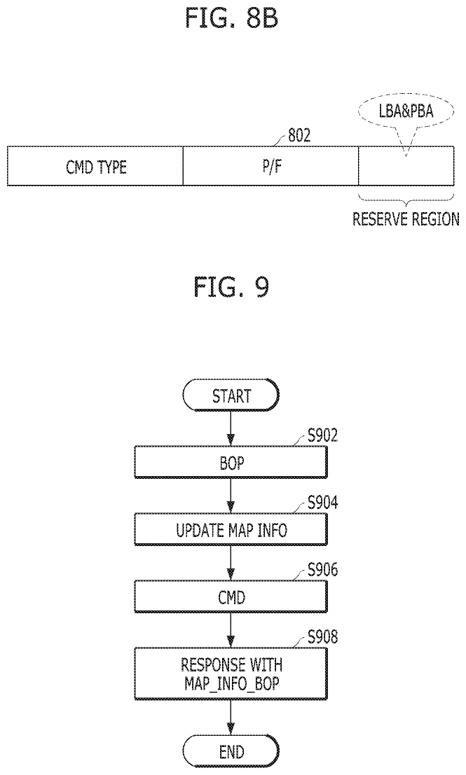

FIG. 9 is a flowchart illustrating an operation of the memory system 110 in accordance with an embodiment of the present invention.

Referring to FIG. 9, in step S902, the controller 130 may control the memory device 150 to perform a background operation BOP. As described earlier with reference to FIG. 1, the background operation BOP may include a garbage collection operation, a wear-leveling operation, and a read re-claim operation. Since the background operation may include a program operation, the map information may be changed according to the background operation. In the case of a garbage collection operation, the controller 130 may control the memory device 150 to read valid data in a victim block, and program the read valid data in a target block. The victim block may be a block whose number of valid pages is less than a predetermined threshold. The target block may be a block whose number of blank pages is greater than or equal to a predetermined threshold. According to the garbage collection operation, the physical address of the valid data may be changed from a page in the victim block into a page in the target block.

In step S904, the controller 130 may update map information MAP INFO which is changed according to the background operation performed in the step S902. The map information MAP INFO may be logical to physical (L2P) information on a physical address corresponding to a logical address. When the physical address corresponding to a logical address for a particular data is changed according to the background operation, the controller 130 may update the map information MAP INFO by loading map information MAP INFO for the logical address into the memory 144. The capacity of the memory 144 may be limited. Since the memory 144 is a volatile memory, the controller 130 may control the memory device 150 to program the updated map information MAP INFO into a memory block.

In step S906, the host 102 may issue a command CMD and provide the controller 130 with the command CMD. The command CMD may include diverse commands, such as a read command, a program command, and an erase command. The controller 130 may control the memory device 150 to perform an operation according to the command CMD in response to the command CMD. As will be described later, according to the second embodiment, whenever the controller 130 provides the host 102 with a response signal RESPONSE for the diverse commands other than a specific command, the controller 130 may increase the update frequency of the map information stored in the host memory 104 by providing the map information MAP INFO which is changed according to a background operation.

In step S908, the controller 130 may provide the host 102 with a response signal RESPONSE in response to an operation for the executed command CMD. The response signal RESPONSE may include an identifier for the command CMD and information on whether the operation for the command CMD has succeeded or not. The controller 130 may generate the response signal RESPONSE including the map information MAP INFO which is changed by the background operation in the step S904. Further, the controller 130 may provide the host 102 with the response signal RESPONSE. The response signal RESPONSE may include a reserve region which is an empty space. The controller 130 may generate the map information MAP INFO including the reserve region.

According to an embodiment, the host 102 may reflect the map information changed by the background operation into the map information in the memory 106, based on the map information MAP INFO in the response signal RESPONSE. Therefore, when a read command is issued for a logical address corresponding to the map information changed by the background operation, the host 102 may perform a mapping operation to provide the controller 130 with a valid physical address. The controller 130 may improve the speed of a read operation by performing a read operation immediately without performing a mapping operation separately based on the provided physical address.

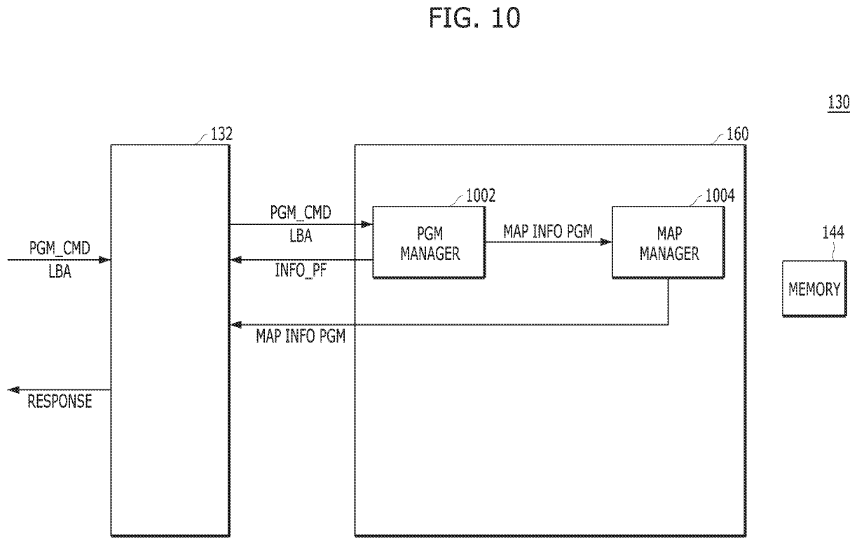

FIG. 10 is a block diagram illustrating the memory system 110 in accordance with an embodiment of the present invention.

FIG. 10 schematically shows only the structures related to the present invention in the data processing system 100 of FIG. 1.

As described earlier with reference to FIG. 1, the controller 130 may include a host interface 132, a memory 1440, and a core 160. The core 160 may include a program (PGM) manager 1002 and a map manager 1004.

The host interface 132 may perform steps S602 and S606 of FIG. 6. The host interface 132 may communicate with the host 102 through at least one among diverse interface protocols, and provide a program command PGM_CMD provided from the host 102 to the program manager 1002. The host interface 132 may transfer a logical address LBA and data to the program manager 1002 together with the program command PGM_CMD. Also, the host interface 132 may transfer a response signal RESPONSE including the pass/failure information INFO_PF provided from the program manager 1002 and program map information MAP INFO PGM provided from the map manager 1004 to the host 102.

The program manager 1002 may perform the operation of the step S602 of FIG. 6. The program manager 1002 may control the memory device 150 to perform a program operation in response to a program command PGM_CMD. The program manager 1002 may control the memory device 150 to program the data for the program command PGM_CMD into an open block. The memory device 150 may provide the program manager 1002 with the pass/failure information INFO_PF, which represents whether the program operation has succeeded or not, after performing the program operation. The program manager 1002 may provide the host interface 132 with the pass/failure information INFO_PF. The program manager 1002 may provide the map manager 1004 with the logical address LBA corresponding to the program command PGM_CMD and the program map information MAP INFO PGM. The program map information MAP INFO PGM represents information on the physical address of a block which is programmed with the data.

The map manager 1004 may perform the operation of the step S604 of FIG. 6. The map manager 1004 may perform a map update operation based on the provided program map information MAP INFO PGM. When map information MAP INFO for a logical address LBA corresponding to the program command PGM_CMD exists in the memory 144, the map manager 1004 may update the map information MAP INFO based on the program map information MAP INFO PGM. When the map information MAP INFO for the logical address LBA corresponding to the program command PGM_CMD does not exist in the memory 144, the map manager 1004 may control the memory device 150 to read the map information MAP INFO from a memory block. The map manager 1004 may perform the map update operation described above after loading the read map information MAP INFO into the memory 144. The map manager 1004 may provide the host interface 132 with the program map information MAP INFO PGM.

The map manager 1004 may perform the operation of the step S512 of FIG. 5B. When the map information MAP INFO of the memory system 110 is changed or updated after providing the host 102 with the map information MAP INFO, the map manager 1004 may manage the map information MAP INFO in a dirty state. The map manager 1004 may manage the map information MAP INFO in a clean state after providing the host 102 with the changed map information MAP. When the read command and the physical address are provided from the host 102, the map manager 1004 may determine the validity of the physical address based on the dirty/clean state of the map information MAP INFO for the logical address corresponding to the read command. The map manager 1004 may not perform a mapping operation when the map information MAP INFO is in a clean state. The map manager 1004 may perform the mapping operation when the map information MAP INFO is in a dirty state.

Although not illustrated in the drawing, the core 160 may include a read manager. When the map information MAP INFO is in a clean state, the read manager 160 may control the memory device 150 to read the data stored at a physical address provided from the host 102 in response to the read command. When the map information MAP INFO is in a dirty state, the read manager may control the memory device 150 to read data from the latest physical address corresponding to the logical address for the read command based on map information MAP INFO according to a mapping operation which is performed by the map manager 1004.

According to the first embodiment, the host interface 132 may be able to secure the validity of the program map information MAP INFO PGM by including the map information MAP INFO PGM which is changed according to a program operation performed in response to a program command PGM_CMD in a response signal RESPONSE and providing the host 102 with the response signal RESPONSE. The host 102 may update the map information stored in the memory 106 based on the program map information MAP INFO PGM. When a read command for the logical address corresponding to the program command PGM_CMD is issued later, the host 102 may perform a is mapping operation and provide the host interface 132 with a physical address together with a read command. Since the map manager 1004 manages the map information MAP INFO for the logical address in a clean state while outputting the response signal RESPONSE, the provided physical address may be highly likely to be valid. Accordingly, the map manager 1004 may not separately perform a mapping operation, and the read manager may control the memory device 150 to read data directly from the provided physical address, thereby improving the speed of a read operation.

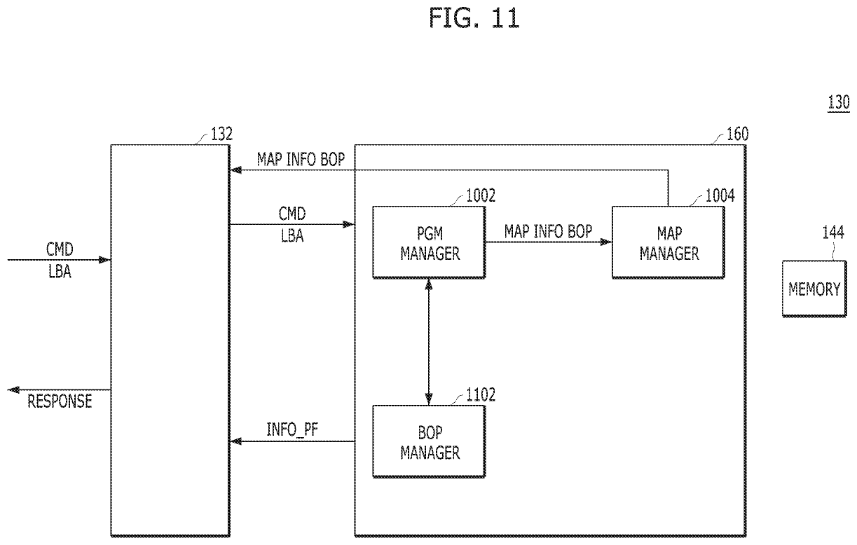

FIG. 11 is a block diagram illustrating the memory system 110 in accordance with an embodiment of the present invention.

FIG. 11 schematically shows only the structure related to the present invention in the data processing system 100 of FIG. 1.

As described earlier with reference to FIG. 1, the controller 130 may include a host interface 132, a memory 1440, and a core 160. The core 160 may include a program (PGM) manager 1002, a map manager 1004, and a background operation (BOP) manager 1102. The program manager 1002, the map manager 1004, and the background operation manager (BOP) 1102 include all circuits, systems, software, firmware and devices necessary for their respective operations and functions.

The background operation manager 1102 may perform the operation of the step S902 of FIG. 9. The background operation manager 1102 may control the memory device 150 to perform a background operation BOP. When the background operation includes a program operation, the background operation manager 1102 may control the program manager 1002 to perform a program operation in the background operation. For example, in the case of a garbage collection operation, the background operation manager 1102 may control the memory device 150 to read the valid data in a victim block and program the valid data in a target block. The victim block may be a block having a number of valid pages less than a predetermined threshold. The target block may be a block having a number of empty pages greater than or equal to a predetermined threshold. The garbage collection operation may include an operation of programming the valid data in the victim block into the target block. The background operation manager 1102 may control the program manager 1002 to program the valid data in the target block.

The program manager 1002 may control the memory device 150 to perform a program operation according to a background operation under the control of the background operation manager 1102. In the case of a garbage collection operation, the program manager 1002 may control the memory device 150 to program the valid data of a victim block in a target block. The program manager 1002 may provide the map manager 1004 with the logical address of data whose physical address is changed and background map information MAP INFO BOP on the changed physical address, according to the program operation based on the background operation.

The map manager 1004 may perform the operation of the step S904 of FIG. 9. The map manager 1004 may perform a map update operation based on the provided background map information MAP INFO BOP. When the map information MAP INFO for a logical address LBA corresponding to the data whose physical address is changed according to the background operation exists in the memory 144, the map manager 1004 may update the map information MAP INFO based on the background map information MAP INFO BOP. When the map information MAP INFO for a logical address LBA corresponding to the data whose physical address is changed according to the background operation does not exist in the memory 144, the map manager 1004 may control the memory device 150 to read the map information MAP INFO from a memory block. The map manager 1004 may perform the map update operation described above after loading the read map information MAP INFO into the memory 144.

The map manager 1004 may store a list including the background map information MAP INFO BOP. As described later, when the response signal RESPONSE including the background map information MAP INFO BOP is outputted, the map manager 1004 may provide the host interface 132 with the background map information MAP INFO BOP having as much as the capacity of the reserve region of the response signal RESPONSE. The map manager 1004 may be able to delete the map information from the list. The map is information may be information provided to the host 102 and included in the reserve region of the response signal RESPONSE.

The host interface 132 may perform the operations of the steps S906 and S908 of FIG. 9. The host interface 132 may communicate with the host 102 through at least one among diverse interface protocols. The host interface 132 may transfer a command CMD provided from the host 102 to the core 160. The command CMD may include diverse commands, such as a read command, a program command, and an erase command. The host interface 132 may transfer the logical address LBA and data to the core 160 together with the command CMD. Also, the host interface 132 may transfer the response signal RESPONSE including pass/failure information INFO_PF and background map information MAP INFO BOP to the host 102, which is described below. The pass/failure information INFO_PF may be provided from the core 160. The background map information MAP INFO BOP may be provided from the map manager 1004.

The core 160 may perform the operation of the step S906 of FIG. 9. The core 160 may control the memory device 150 to perform an operation for the command CMD in response to the command CMD.

Although not shown in the figure, the core 160 may include not only a program manager 1002 but also a read manager and an erase manager. As described above with reference to FIG. 10, the program manager 1002 may control the memory device 150 to perform a is program operation in response to the program command PGM_CMD when the command CMD is a program command PGM_CMD. Similarly, when the command CMD is a read command, the read manager may control the memory device 150 to perform a read operation in response to the read command. When the command is an erase command, the read manager may control the memory device 150 to perform an erase operation in response to the erase command. The core 160 may provide the host interface 132 with pass/failure information INFO_PF representing whether the operation corresponding to the command CMD has succeeded or failed.

The host interface 132 may transfer a response signal RESPONSE in response to the command to the host 102 based on the pass/failure information INFO_PF and the background map information MAP INFO BOP. The host interface 132 may store a command identifier and the pass/failure information INFO_PF in the first and second regions of the response signal RESPONSE and store the background map information MAP INFO BOP in the reserve region, as described above with reference to FIG. 8B.

According to the embodiments, a memory system may include map information which is changed by a background operation in a response signal in response to a command and output the response signal. In response, a host may update the map information stored in a host memory based on the map information. The host may perform a mapping operation based on the updated map information, and output a read command and a latest physical address corresponding to a logical address of the read command. The memory system may quickly read data stored at the latest physical address without performing a mapping operation in response to the read command.

While the present invention has been described with respect to the specific embodiments, it will be apparent to those skilled in the art that various changes and modifications may be made without departing from the spirit and scope of the invention as defined in the following claims.

What is claimed is:

1. A data processing system, comprising:
a host; and
a memory system suitable for outputting map information to the host;
wherein the host is suitable for performing a mapping operation based on the map information and outputting, to the memory system, a physical address corresponding to the mapping operation, and
wherein the memory system generates a response signal in response to a command, the response signal including changed map information which is changed after the map information is outputted and outputs the response signal to the host.

2. The data processing system of claim 1, wherein the changed map information includes map information which is changed according to a background operation.

3. The data processing system of claim 1, wherein the changed map information includes map information which is changed according to a program operation that is performed in response to a program command.

4. The data processing system of claim 1, wherein the host includes a memory storing the map information.

5. The data processing system of claim 4, wherein the host updates the map information that is stored in the memory based on the changed map information in the response signal.

6. The data processing system of claim 4, wherein, when the map information in the memory includes map information for a logical address corresponding to a read command, the host performs the mapping operation.

7. The data processing system of claim 1, wherein the mapping operation includes searching for the physical address corresponding to a logical address for a read command.

8. A memory system, comprising:
a memory device;
a host interface suitable for outputting map information;
a program manager suitable for controlling the memory device to perform a program operation;
a map manager suitable for updating the map information to generate updated map information; and
a read manager suitable for controlling the memory device to perform a read operation based on an externally provided physical address,
wherein the host interface generates a response signal in response to a command, the response signal including the updated map information after the map information is outputted, and outputs the response signal.

9. The memory system of claim , wherein the updated map information includes
map information which is changed according to the program operation performed as a background operation.

10. The memory system of claim 8, wherein the updated map information includes
map information which is changed according to the program operation that is performed in response to a program command.

11. The memory system of claim 9, further comprising:
a background manager suitable for controlling the program manager to perform the program operation as the background operation.

12. The memory system of claim 8, wherein the host interface generates the response signal, the response signal including a region having the updated map information.

13. The memory system of claim 9, wherein the map manager stores a list including the map information which is changed according to the background operation.

14. The memory system of claim 13, wherein the map manager provides the host interface with map information having as much capacity as the reserve region of the response signal among the map information included in the list.

15. The memory system of claim 8, wherein the response signal includes the updated map information, a command identifier, and information indicating a pass or a failure of a command operation.

16. The memory system of claim 8, wherein the map manager performs a mapping operation when the physical address is invalid.

17. The memory system of claim 16, wherein the map manager invalidates the physical address, when the updated map information is changed after the map information is outputted.

18. A data processing system, comprising:
a host; and
a memory system including a memory device, suitable for:
transmitting map information to the host;
performing a background operation on the memory device;
updating the map information based on the background operation;
generating a response signal in response to a command from the host, the response signal including updated map information; and
transmitting the response signal to the host.
